(19) United States
(12) Patent Application Publication
(10) Pub. No.: US 2011/0313937 A1
(43) Pub. Date: Dec. 22, 2011

(54) Vehicle rental system and method

(76) Inventors: Robert Duane Moore, JR., Edmond, OK (US); Michael Anthony Francis, Piedmont, OK (US)

(21) Appl. No.: 12/802,942

(22) Filed: Jun. 17, 2010

(51) Int. Cl. G06Q 50/00; G06K 5/00; G06Q 10/00; G06F 7/08

(52) U.S. Cl. 705/307; 235/381; 235/382

(57) ABSTRACT

A system and method are provided for facilitating a remote live vehicle rental transaction between a customer service representative (CSR) and a customer and providing a vehicle key device to the customer without the need for a CSR at the site of the key or vehicle, where the vehicle may be in an unsecured lot. In particular, the system includes a customer interface device (CID), a remotely located CSR apparatus for facilitating live communications between the customer and CSR, and a key safe. The key safe includes a code input device for recognizing a code provided by the CID, the code input device configured to unlock a locker containing the vehicle key device when the code is recognized. Alternatively, the CID dispenses an electronic key card or provides the customer with an electronic signal device or two-dimensional image (such as a bar code) to enter and/or operate a rental vehicle, or a central system automatically remotely unlocks the vehicle when the rental agreement is formed.

### FIELD OF THE INVENTION

The present invention relates to systems and methods of providing customer service interactions. More particularly, the invention relates to a system and method for performing automated and/or remote live customer service representative (CSR) interactions with a rental customer to facilitate a vehicle rental transaction and to provide the rental customer with means, such as a key, keycard, electronic signal device, or two-dimensional image (such as a bar code) to enter and/or operate a rental vehicle.

### BACKGROUND OF THE INVENTION

Typical existing methods of vehicle rental and vehicle key delivery require either the presence of a live CSR at the site of the vehicle key and vehicle, so that the live CSR may perform the vehicle rental and provide the customer with a key to the rented vehicle only once the rental transaction is completed; or a secured lot for storing unlocked vehicles with keys inside the vehicles, access to the secured lot being limited to rental customers bearing proof of a rental transaction, such as a rental contract, which may for example be presented to a lot attendant. However, there is substantial demand for vehicle rental in areas where it may not be commercially ideal or even feasible to construct and maintain a secured lot or to retain a full-time on-site CSR to service any one location. For example, this may be case in rural and suburban areas where rental volume is less geographically dense or in urban areas where space is not available for a secured lot and/or a full-time on-site CSR. In addition, car rental businesses and other commercial entities could mutually benefit from having vehicle rental available on sites such as hotels and car repair shops, without the need for the other commercial entities to provide space or facilities for a live CSR or a secured lot.

A need therefore exists for a system and method for providing remote live CSR interactions with a vehicle rental customer to facilitate a rental transaction and to provide the customer with access to (i.e., means of entering and/or starting) a vehicle, in which the vehicle may be locked at the time of the rental transaction and may be parked in a local unsecured lot.

### BRIEF SUMMARY OF THE INVENTION

In accordance with one aspect of the present invention, a system is provided for facilitating a vehicle rental and providing a rental customer with access to the rented vehicle. At a point-of-sale location, the system comprises a customer interface device (CID), which may for example be a kiosk, a wall-mounted terminal, a desktop or portable computer, a customer's cellular phone or PDA, or any other device suitable for receiving and transmitting data; one or more vehicles available for rental located proximate to the CID; and a key safe containing key devices for accessing (i.e., unlocking and/or starting) the one or more vehicles, the key safe being proximate to the one or more vehicles and optionally being attached to the CID. As used herein, “proximate to” means “within a reasonable walking distance of,” such that a customer could conveniently perform the rental transaction, obtain a key device, and access the rented vehicle on foot. At a remote CSR location, the system comprises a CSR apparatus for use by a CSR in conducting a rental transaction with a customer at the CID. As used herein, “remote” means beyond a reasonable distance such that a customer could not immediately or conveniently have a face-to-face interaction with the remotely located CSR. Both the CID and the CSR apparatus include one or more data input devices, data transmission devices, data receiver devices, and output devices for presenting received communication data to the customer and CSR, respectively. As used herein, “data” generally encompasses oral communications, visual body-language communications (such as a nod of the head), written/typed verbal communications, and any signals perceived by the CID and CSR apparatus. Suitable data input devices may include any of a keyboard, a touch screen, a microphone, and a video camera, and suitable output devices may include any of a video screen, an audio speaker and a printer.

In one embodiment, the CID also includes a printer configured for printing a key safe code image, such as a bar code, onto a substrate, where the substrate may for example be a rental contract, and for dispensing the substrate. The CSR apparatus is configured to receive instructions from the CSR to direct the CID to print the key safe code image onto the substrate and to transmit said instructions to the CID to initiate printing and/or dispensing. The key safe includes one or more locked lockers, one of the locked lockers containing a key device configured to access the subject vehicle. The key device may be any suitable device for accessing (i.e., unlocking and/or starting) a vehicle, which may for example be a traditional mechanical key or an electronic card or device configured to unlock and/or start the vehicle. A scanner is included on the key safe, and when the customer scans the key safe code at the scanner, the locked locker is configured to unlock to permit the customer to manually obtain the key device from inside the locker. It should be noted that if the CID is a portable handheld device, the key safe code image may advantageously be displayed directly on a screen of the CID for scanning at the key safe, thus eliminating the need for a printer.

In one embodiment, the system further comprises an automated key device inventory system. According the key device inventory system, a key fob is connected to each key device, and a key fob detector detects the presence of a particular key fob in a particular locker. Each key fob is programmed with a unique code associated with the vehicle to whose key device the key fob is attached. The CSR apparatus is configured to receive a remote signal indicating that a particular key fob is detected in a particular locker and to present a message to the CSR indicating that the key device is in the locker.

In another embodiment, the key safe code image further comprises an alphanumeric code and the key safe scanner further comprises an alphanumeric code input device. The input device is configured to unlock the locker when the rental customer manually enters the alphanumeric code into the input device, providing alternative means of access in case scanning the key safe code fails.

In yet another embodiment, the key safe further comprises an input device permitting the rental customer to provide input indicating a return process, the key safe configured so that when the rental customer provides the input indicating the return process, an available locker is automatically unlocked so that the rental customer may return the key device to the available locker at the end of the rental, the locker then automatically relocking when the customer closes the locker. In this embodiment, the key safe may include a display device prompting the rental customer to press a button of the input device indicating a return process to automatically unlock the available locker.

In accordance with another aspect of the invention, an alternative system is provided for facilitating a vehicle rental and providing a rental customer with a key card for access to a vehicle. The alternative system includes a CID and CSR apparatus substantially as described above, but omits a key safe. Instead, the CID is configured to dispense an electronic key card (or other key device) configured to access a rented vehicle. The CSR apparatus is configured to receive instructions from the remotely located CSR to dispense the key card and to transmit said instructions to the CID to initiate dispensing of the key card.

In one embodiment, the CID further comprises a key card reader configured to read data from the key card and a transmission device configured to transmit said data to a remote location. A remotely located vehicle lock activation device is configured to receive said key card data and to remotely activate a key card detector on the vehicle to provide access to the vehicle when the key card detector detects the key card.

In another embodiment, the CID comprises a key card writer, instead of or in addition to a key card reader, the key card writer configured to write data to the key card. The vehicle further comprises a key card detector configured to read said data, and the vehicle is configured to unlock and/or start when the key card detector reads said data.

In accordance with yet another aspect of the present invention, a method is provided for renting a vehicle and for providing a rental customer with a key device for access to the vehicle via a customer CID located remotely from a CSR. The CSR and the customer communicate with each other via a CSR apparatus and the CID to create a vehicle rental agreement. The CSR then enters instructions into an input device of the CSR apparatus to instruct the CID to print and dispense a key safe code image on a substrate, preferably on a rental contract, the instructions are transmitted to the CID, and a printer in the CID prints the rental contract with the key safe code image printed thereon. The customer manually receives the substrate and places the key safe code image proximate to a scanner of a key safe located proximate to the CID, or enters an alphanumeric code included in the key safe code image into an input device of the key safe, to unlock a locked locker of the key safe, the locker containing a key device for accessing the subject vehicle of the rental agreement. The customer manually retrieves the key device from the locker and uses the key device to access the vehicle.

In one embodiment, a key fob detector in the locked locker detects the presence of a key fob connected to a key device in the locker and transmits a signal to the CSR apparatus indicating that the key device is in the locker. The CSR apparatus presents a message to the CSR that the key device is in the locker, and after the CSR receives the message, the CSR enters the instructions into the CSR apparatus to instruct the CID to print and dispense the key safe code image.

In another embodiment, the customer returns to the CID at the end of a rental period and the customer and CSR exchange further communications to end the rental. The CSR then enters instructions into an input device of the CSR apparatus to instruct the CID to print and dispense a rental receipt, the CID receives the instructions and prints the receipt, and the customer manually receives the receipt. The CID printer may print a key safe code image onto the receipt for the customer to unlock a particular locker of the key safe in the same manner described above to return the key device to the locker and close the locker to automatically relock the locker.

In accordance with still another aspect of the invention, a method is provided for renting a vehicle and for providing a rental customer with a key card for access to the vehicle via a customer CID located remotely from a CSR. The customer and CSR communicate with each other via the CID and a CSR apparatus to create a vehicle rental agreement. Then, the CSR enters instructions into an input device of the CSR apparatus to instruct the CID to dispense an electronic key card (or other key device) configured to access the vehicle. The instructions are transmitted to the CID, the CID receives the instructions, and the CID dispenses the key card. The customer manually retrieves the dispensed key card and uses the key card to access the vehicle.

In one embodiment, a card reader in the CID reads data from the key card and transmits the key card data to the CSR apparatus. The CSR inputs the key card data into a remotely located activation system to remotely activate a key card detector of the vehicle to unlock and/or start the vehicle when the key card detector detects the key card. Alternatively, the CSR inputs instructions to write data to the key card, and a card writer in the CID writes the data to the key card to configure the key card to access the vehicle when a key card detector of the vehicle reads the data from the key card.

In accordance with yet another aspect of the invention, a method is provided for renting a vehicle and providing a rental customer with a key device for access to the vehicle via a CID located remotely from a CSR. The CSR and rental customer communicate with each other via a CSR apparatus and the CID to create a vehicle rental agreement pertaining to the locked vehicle. The CSR then enters instructions into an input device of the CSR apparatus to instruct the CID to print and dispense a vehicle rental contract, the instructions are transmitted to the CID, and the CID prints and dispenses the contract. The customer manually receives the contract and presents the contract to an on-site agent at a location proximate to the CID, and the on-site agent provides to the customer a key device to the vehicle.

### BRIEF DESCRIPTION OF THE DRAWINGS

FIG. 1 is a schematic representation of a system and method for vehicle rental and delivery of conventional vehicle key devices according to the invention.

FIG. 2 is a schematic representation of the system and method represented in FIG. 1 linking a plurality of CIDs to a plurality of CSR apparatus via a server or network.

FIG. 3 is a depiction of an alternative key safe having an input keypad in accordance with one aspect of another embodiment of a rental and key device delivery system according to the invention.

FIG. 4 is a schematic representation of still another embodiment of the invention, depicting a system and method for vehicle rental and direct dispensing of electronic key cards for vehicle access.

FIG. 5 illustrates a key device inventory system in accordance with any rental and key device delivery system of the present invention that incorporates a key safe with a plurality of key lockers.

FIG. 6 is a depiction of a key safe that is attached to a CID according to one embodiment of the invention.

FIG. 7 is a depiction of an automated key device dispenser attached to a CID according to another embodiment of the invention.

FIG. 8 is a schematic representation of yet another embodiment of the invention, depicting a system and method for vehicle rental and remote unlocking of a rented vehicle.

### DETAILED DESCRIPTION OF THE INVENTION

With reference to the Figures generally, in accordance with the present invention, systems and methods for performing vehicle rental transactions and delivering a key device for vehicle entry to a rental customer are provided. In particular, systems and methods are provided in which a CID, a key device for a vehicle, and the vehicle itself are at one geographic location, and the CSR, if any, performing the rental transaction with the rental customer is at another, remote geographic location.

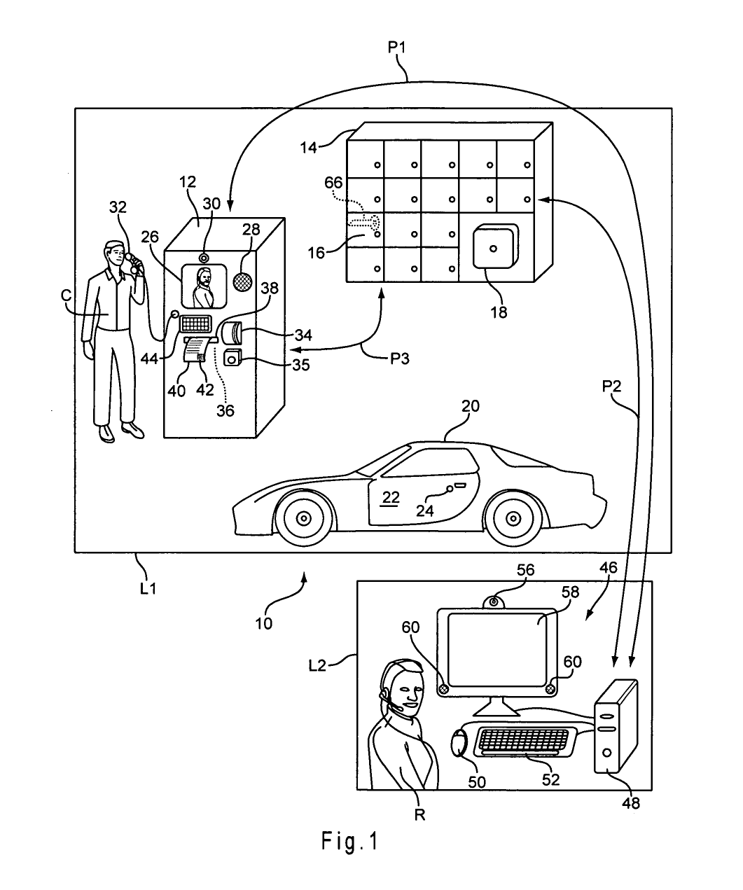

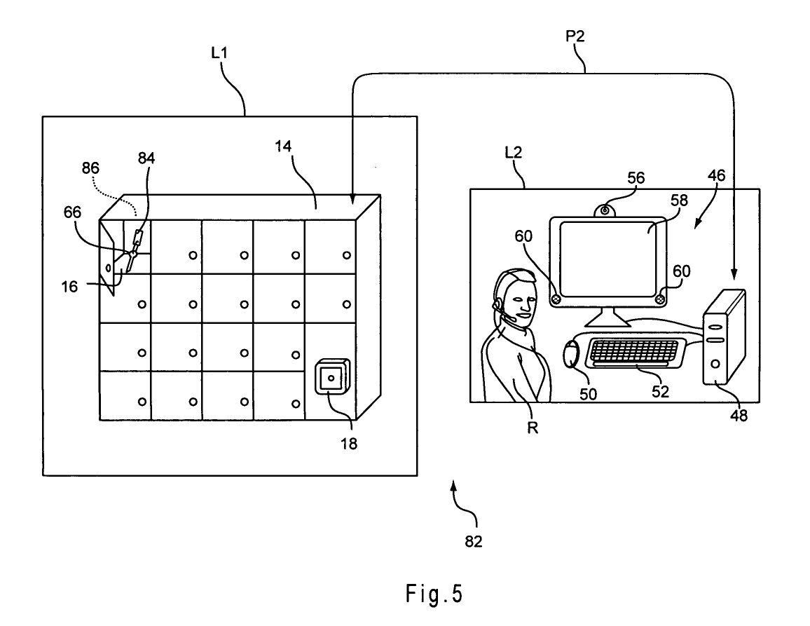

Turning to FIG. 1, a vehicle rental and key device delivery system 10 includes at a point of sale (POS) location L1 a virtual customer service representative (VCSR) CID 12, which may for example be a suitable kiosk available from NCR Corporation, such as the Touchport™ 70 kiosk; a key safe 14, which may for example be a key safe available from Traka plc, particularly when an automated key device inventory system is used as described in more detail below with reference to FIG. 5, key safe 14 having a plurality of individual key lockers 16 and a code reader 18; and a vehicle 20 which at the time of the rental transaction may be locked and parked in an unsecured lot, vehicle 20 including a vehicle door 22 with a conventional mechanical lock 24. CID 12 preferably includes a display screen 26 and a speaker 28 for presenting stored information, automated messages, and/or live communications from a CSR to a rental customer C; a camera 30 and telephonic handset 32 for receiving audio and/or visual communication data from customer C; a credit card reader 34; a two-dimensional bar code scanner 35 (for driver's license scanning to verify a customer's identity and/or that the customer is a licensed driver); and a printer 36 (hidden) for printing and dispensing through a slot 38 a rental contract 40 bearing a key safe code, which is depicted in FIG. 1 as a bar code 42. Display screen 26 is preferably a touch screen configured so that customer C may acknowledge receipt of a message and/or make a selection by touching an appropriate part of the screen. A customer key input device such as a keyboard and/or keypad, shown as a key input device 44, may also be included alternatively or in addition to display screen 26 being a touch screen, although omitting key input device 44 in favor of display/touch screen 26 may be preferred for simplicity and compactness of the design of CID 12.

At a remote location L2, a CSR apparatus 46, which may for example be a typical personal computer as depicted, is configured to send and receive communication data and other data to and from CID 12 via a first transmission path P1 and to send and receive data to and from key safe 14 via a second transmission path P2. CSR apparatus 46 typically includes a processing unit 48 and input/output devices such as mouse 50, keyboard 52, headset 54, video camera 56, one or more monitor screen(s) 58, and speakers 60. Transmission paths P1 and P2 may for example be a part of a network composed of a dedicated circuit, wired broadband, the Internet, a wireless network, or any other suitable transmission path infrastructure.

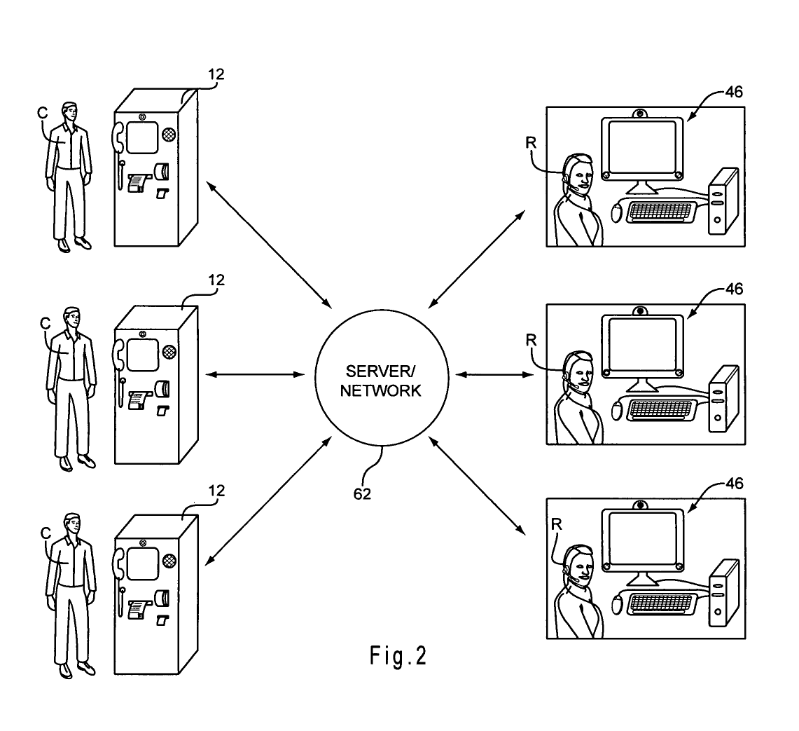

In a typical rental transaction facilitated by system 10, customer C begins a transaction with any suitable action to initiate a call to a CSR R from CID 12, for example by pressing a “call” area on the touch screen. Other suitable call initiating actions include, without limitation, customer C pressing a key of key input device 44 or simply picking up handset 32, although a “hook” feature to indicate that handset 32 has been picked up and key input device 44 are both optional and may be advantageously omitted to simplify CID 12. Preferably, a system includes a plurality of CIDs 12, a plurality of CSR apparatus 46, and call routing software (not shown). The software may be stored in and operated by CIDs 12, a remote server or network 62 linking CIDs 12 to CSR apparatus 46, and/or in CSR apparatus 46. As depicted schematically in FIG. 2, the software connects customer C to the next available CSR R through the corresponding CSR apparatus 46. For example, Live Expert® software available from ClairVista, LLC may be used to route calls from customers C to CSR's R.

Then, CSR R guides customer C through a rental transaction as if they were standing face to face. CSR R requests information from customer C and customer C speaks into handset 32 and inputs responses by touching screen 26, sliding a credit card in credit card reader 34, presenting a driver's license either by sliding it in the credit card reader 34 or scanning it in the bar code scanner 35 (as an alternative, less secure method, customer C may simply provide or enter his or her driver's license number), and/or pressing keys on key input device 44. At the end of the transaction, CSR R enters input into CSR apparatus 46 instructing CID 12 to print rental contract 40. Rental contract 40 includes a key safe code printed thereon, which may for example be bar code 42 as depicted in FIG. 1, configured to provide access to a particular locked locker 16 of key safe 14 containing the key device for vehicle 20. Advantageously, the system may be configured for CSR R to submit instructions via transmission path P2 to key safe 14 to reprogram code reader 18 to unlock the particular locker 16 when it scans bar code 42 or, alternatively, for CID 12 to automatically submit the same instructions to key safe 14 via a transmission path P3, either directly or through a remote server. Similarly, code reader 18 may be reprogrammed automatically or at the initiative of CSR R not to accept the same bar code 42 either again after customer C returns the key device to locker 16 at the end of a rental or after a predetermined time period, thus preventing unauthorized access to key devices.

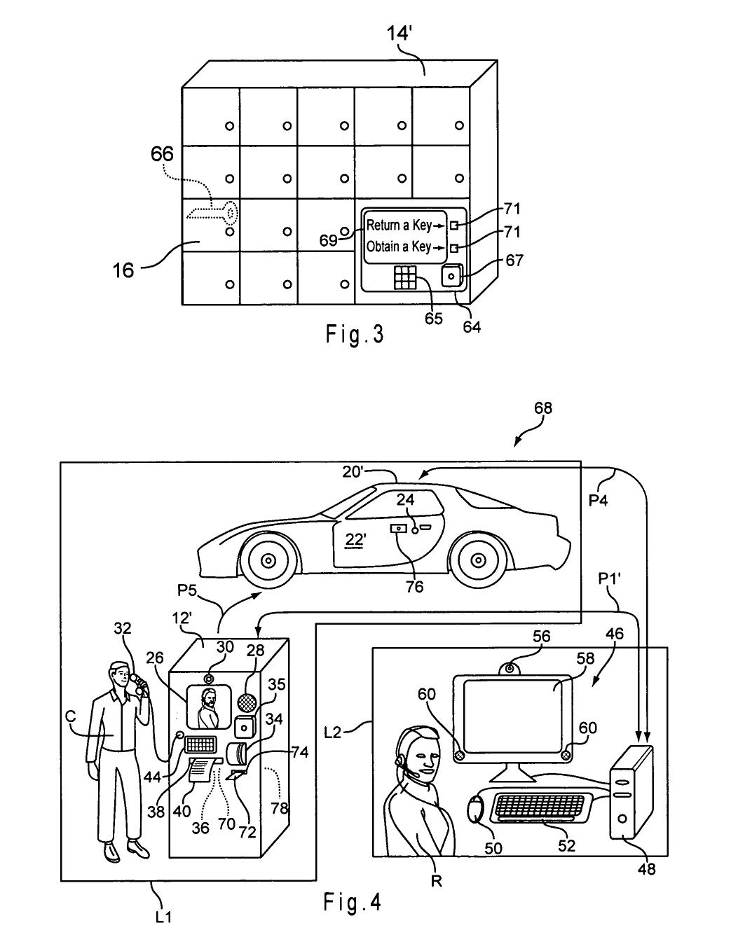

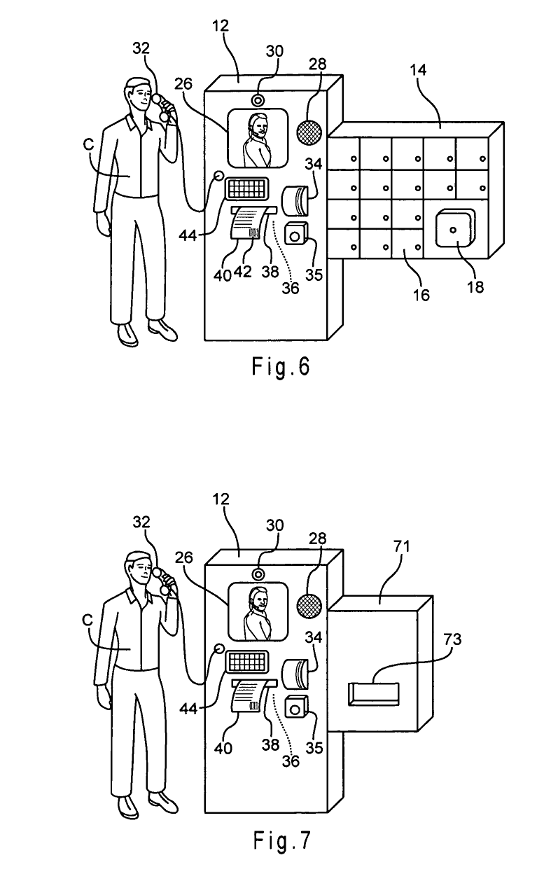

Customer C then takes contract 40 to key safe 14 and scans bar code 42 with code reader 18 (in this case a bar code scanner). Key safe 14 is advantageously a separate structure at location L1 (i.e., within short walking distance of CID 12 and vehicle 20), as shown in FIG. 1. In this manner, a single key safe 14 may be centrally located to serve a plurality of CIDs 12. However, a key safe or key device dispenser directly attached to a CID is also within the scope of the invention, as described in more detail below with reference to FIGS. 6 and 7. Code reader 18 recognizes bar code 42 as associated with the particular locker 16 and causes the particular locker 16 to be unlocked. Alternatively, the key safe code printed on contract 40 may comprise a manually enterable code such as an alphanumeric code, which customer C may manually enter into an input device 64 by pressing keys on a keypad 65 as depicted on alternative key safe 14′ in FIG. 3, and a particular locker 16 containing a key device 66 could be automatically unlocked when input device 64 recognizes that its associated code has been entered. Optionally, but preferably, input device 64 also comprises a bar code scanner 67, and the key safe code printed on contract code printed on contract 40 comprises both bar code 42 and an alphanumeric code. In this manner, customer C may first attempt to scan bar code 42 into scanner 67, and if scanning fails, for example due to printer 36 having a row of damaged elements so that it does not print bar code 42 properly, customer C may instead manually enter the alphanumeric code on keypad 65 as a backup method of unlocking the particular locker 16. Input device 64 may further include a display screen 69 prompting customer C to press a button 71 indicating that customer C desires to obtain a key device, and then prompting customer C to either scan bar code 42 into scanner 67 or enter the alphanumeric code on keypad 65. Once input device 64 recognizes bar code 42 or the alphanumeric code, the locker 16 either automatically opens or is enabled to be opened by customer C, who then retrieves key device 66 from within the locker 16, takes key device 66 to vehicle 20, and uses key device 66 to unlock lock 24 of vehicle door 22 and/or to start vehicle 20. It should be noted that instead of or in addition to a conventional key as depicted in FIG. 1, key device 66 may include an electronic key card, a key remote device as known in the consumer automotive industry, or any other suitable device for accessing a vehicle.

With reference to FIG. 5, an automated key device inventory system 82, which may be incorporated into any system and method according to the invention that includes a key safe, is illustrated schematically. In accordance with system 82, a key fob 84 is included attached to each key device 66, and a key fob detector 86 (hidden) in each locker 16 of key safe 14 is configured to detect the presence of key fob 84 in the particular locker 16. For example, key fob 84 may emit a RFID signal that is detected by detector 86, either when key fob 84 is located anywhere in the particular locker 16, or when key fob 84 is plugged into a suitable receptacle (not shown) located in locker 16. Thus, whenever a particular detector 86 detects the presence of a particular key fob 84 in a particular locker 16, CSR R is able to verify that the corresponding key device 66 is present in the particular locker 16 before renting the corresponding vehicle to customer C at CID 12 and directing CID 12 to print a key safe code corresponding to the particular locker 16. For instance, a signal may automatically be transmitted from key safe 14, either to CSR apparatus 46 via transmission path P2, or to a remote server from which the information may be accessed by CSR apparatus 46, whenever a particular key fob 84 is detected in a particular locker 16. In addition to key safe 14 as noted above, suitable key fobs 84 for key device inventory system 82 are also available from Traka plc. In some cases the key fob may be integral with the key device. Persons of skill in the art will also understand that other methods of inventorying key devices in the key safe may be used.

At the end of a rental, customer C returns vehicle 20 to the lot, returns key device 66 or the other suitable entry means to an available locker 16, closes the locker 16 (locker 16 automatically relocking when closed by customer C), and returns to CID 12. For example, each locker 16 may be kept unlocked and opened or openable whenever a key device 66 is not located in the locker 16. The task of keeping available lockers 16 unlocked may be performed by an attendant (not shown) at location L1 who monitors key safe 14, 14′, or alternatively, if automated key device inventory system 82 is employed, key safe 14, 14′ may be configured to automatically disengage the lock of any locker in which a key fob 84 is not detected. Still another option is for display screen 69 of input device 64 to prompt customer C to press one of buttons 71 indicating a return process, at which point an available locker 16 is unlocked so that customer C may return key device 66 to the available locker 16 and close locker 16, when locker 16 will be automatically locked. Customer C then initiates a transaction at CID 12, which may again for example be performed by pressing “call” on screen 26, or by pressing a key on keypad 44 or simply lifting receiver 32. CSR R walks customer C through a return transaction, again as if they were standing in front of each other. CSR R requests information from customer C, who again enters information by pressing screen 26 or key input device 44, by speaking into receiver 32, or by scanning a credit card into credit card reader 34. At the transaction's end, CSR R enters input into CSR apparatus 46 to direct CID 12 to print a receipt and dispense the receipt (not shown) through slot 38 in substantially the same manner as described and illustrated for contract 40 with reference to FIG. 1.

Alternatively, customer C may return to CID 12 before returning key device 66, and the printed receipt may comprise a new bar or alphanumeric code, activated for recognition by code reader 18 or input device 64 of key safe 14, 14′ in any suitable manner as described above. Customer C may then scan or enter into code reader 18 or input device 64 as appropriate, to unlock an available locker 16, return key device 66 to the available locker 16, and close the available locker 16.

While key safe 14 as a separate structure from CID 12 provides certain advantages as noted above, it may instead be desired for a key delivery device to be integrated with or directly attached to a CID. For example, key safe 14 (or 14′, not shown) having the structure and function already described may simply be attached to one side of CID 12 as shown in FIG. 6. Alternatively, a key device dispenser 71 with a key device slot 73 may be attached to one side of CID 12 as shown in FIG. 7. By CID 12 directly communicating with key device dispenser 71 to instruct key device dispenser 71 to dispense the appropriate key device through key device slot 73, the need for a key safe code 42 to be manually scanned or entered at a key safe could thus be eliminated.

Although the systems and methods as described in the foregoing paragraphs with reference to FIGS. 1, 3 and 5-7 include storing key devices in a key safe with coded access performed by customer C or in an automated dispenser attached to a CID, it may be desirable in some instances, for example when renting particularly high-end vehicles, for an on-site agent (not shown) at location L1 to instead retain and manually provide vehicle key devices to customers. For instance, customer C may receive contract 40 from CID 12 and give contract 40 to the on-site agent for the on-site agent to retrieve a key device 66 from key safe 14, 14′ by scanning bar code 42 or entering an alphanumeric code in the manner described above, where key safe 14, 14′ may be in a secure location not accessible to customer C. Alternatively, key safe 14, 14′ may be omitted, and the on-site agent may simply store key device 66 in any suitable manner and provide key device 66 to customer C when customer C presents contract 40 to the on-site agent.

An alternative embodiment of a vehicle rental and key device delivery system and method is depicted in FIG. 4. System 68 includes a CSR apparatus 46 linked to an alternative CID 12′ via a transmission pathway P1′ and to an alternative vehicle 20′ via transmission pathway P3. CID 12′ contains all of the devices of CID 12 and additionally a key card dispenser 70 (hidden) configured to dispense a key card 72 through a key card slot 74 when the appropriate instructions are input by CSR R into CSR apparatus 46 and transmitted to CID 12′. Key card 72 may be a magnetically encoded, RFID-emitting, or other type of key card which may be waved in front of or inserted into a card reader to unlock a vehicle door and/or start a vehicle. For example, key card 72 may be an appropriate key card available from HID Global. Thus, in accordance with system 68, vehicle 20′ includes a card reader 76 configured to unlock an alternative vehicle door 22′ when card reader 76 recognizes key card 72. As shown in FIG. 4, card reader 76 may be in addition to a conventional keyhole 24, and a conventional key (not shown) may be located inside vehicle 20′ for ignition purposes and/or as an alternative means of unlocking door 22′. Alternatively, card reader 76 may be the sole means of unlocking vehicle 20′, while vehicle 20′ may be configured to be started by key card 72, by a conventional key located inside vehicle 20′, or by other suitable means.

In still another embodiment in which a vehicle 20, 20′ is parked in a secured lot (not shown), key card 72 may be configured to be scanned at the entrance and/or exit of the secured lot to permit customer C to enter the secured lot and/or permit customer C to exit the secured lot in vehicle 20, 20′. Where a conventionally keyed vehicle is used in this embodiment, the vehicle may be unlocked in the secured lot with a conventional key inside the vehicle, as vehicle theft is substantially prevented by the key card-controlled access to and egress from the secured lot. Where key-card accessible vehicle 20′ is used in this embodiment, key card 72 may function to unlock vehicle 20′ substantially as described above, in addition to providing access to and egress from the secured lot.

Advantageously, key cards 72 provide additional flexibility compared to conventional mechanical vehicle keys in that they are more susceptible to automated dispensing from a CID, and they may be remotely activated and deactivated for security purposes. For example, CID 12′ may include a plurality of key cards 72 that initially will not be accepted by a card reader 76 on a vehicle 20′ available for rent, to prevent the potential security concern of someone breaking into CID 12′, stealing key cards 72, and using them for unauthorized entry into vehicles 20′. To facilitate the activation of a particular key card 72, CID 12′ may include an internal card reader 78 (hidden) configured to automatically read key card 72 before dispensing key card 72 and to transmit data identifying key card 72 to CSR apparatus 46. CSR R may then input instructions into CSR apparatus 46 to reprogram vehicle card reader 76 to accept key card 72, and CSR apparatus may transmit those instructions to vehicle 20′ via a transmission path P4. Then, vehicle card reader 76 may be reprogrammed to accept the particular key card 72. Alternatively, the key card activation process may be performed automatically by CID card reader 78 automatically transmitting data identifying the particular key card 72 to vehicle 20′ with instruction to reprogram vehicle card reader 76 to accept key card 72, either directly or via a remote server, via transmission path P5. Similarly, key card 72 may be deactivated at the initiative of a CSR upon theft or loss of key card 72 or expiration of a rental period, or automatically by a remote server upon expiration of a rental period, by the CSR or remote server instructing vehicle card reader 76 to be reprogrammed. In still another variation, CID card reader 78 may instead or additionally be a card writer, so that activating key card 72 may comprise CID card reader/writer 78 writing data to key card 72 so that key card will be accepted by vehicle card reader 76, instead of or in addition to the reprogramming of vehicle card reader 76 itself.

Optionally but preferably, system 68 is configured so that, upon returning vehicle 20′, a rental customer has the option of either returning key card 72 to be recycled by inserting it into a CID 12′ or retaining key card 72 and then reactivating key card 72 at a later date in a subsequent rental transaction, for example by inserting key card 72 into a CID 12′ to be reactivated in the same manner in which it was initially activated. CID 12′ may be configured with a card acceptor slot to accept key cards 72 for return or reactivation, which is either the same slot 74 through which key cards are dispensed or a separate key card acceptor slot 80.

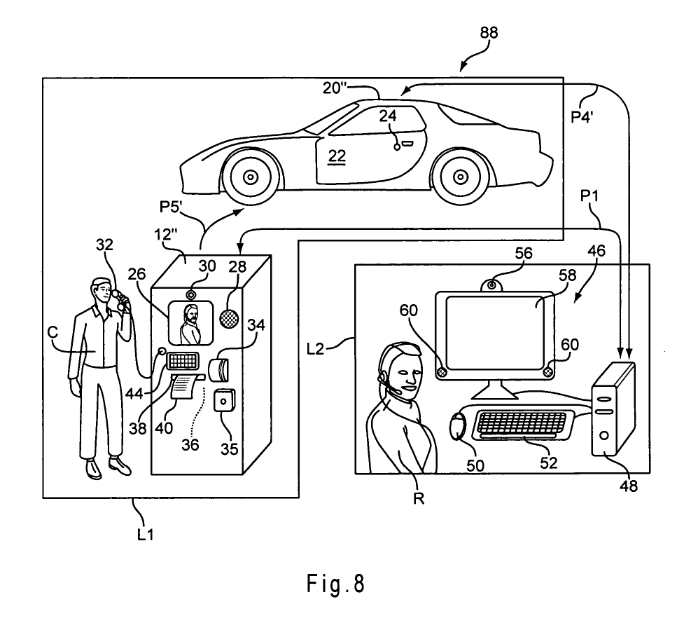

Turning to FIG. 8, a vehicle rental and remote vehicle unlocking system 88 according to still another aspect of the present invention is illustrated. System 88 includes at L1 a CID 12″ and a vehicle 20″ configured with suitable equipment (not shown) for remote unlocking, and at L2 a CSR apparatus 46 including all the elements described above. CID 12″ includes all of the devices of CID 12. Additionally, at least one of CSR apparatus 46 and CID 12″ is configured to send a signal to vehicle 20″ to remotely unlock vehicle 20″ via a corresponding transmission pathway P4′ or P5′, respectively. Thus, in a method of implementing system 88 to facilitate vehicle rental and unlocking, a signal to unlock vehicle 20″ may be sent automatically from CID 12″ or CSR apparatus 46, or initiated by an action of CSR R, upon formation of a rental agreement. Then, customer C may proceed to vehicle 20″ and enter vehicle 20″, finding inside vehicle 20″ any suitable key device for starting and/or subsequent entry into vehicle 20″.

Advantageously, any of the systems and methods described herein may incorporate GPS technology to help customer C locate vehicle 20, 20′, 20″. For example, vehicle 20, 20′, 20″ may include a GPS device to sense its position and appropriate means to transmit its position to CID 12, 12′, 12″, so that CID 12, 12′, 12″ may display a map on screen 26 indicating the location of CID 12, 12′, 12″ and the location of vehicle 20, 20′, 20″. Additionally or alternatively, a similar map may be displayed on screen 58 of CSR apparatus 46 so that CSR R may provide customer C with directions to vehicle 20, 20′, 20″ from CID 12, 12′, 12″.

In accordance with any of the systems and methods described herein, the system may be configured so that CSR R may input instructions into CSR apparatus 46 to initiate downloading of software applications which may for example be cell-phone, smart phone or PDA applications and/or in-car applications to customer C's cell phone, smart phone or PDA or any other suitable in-vehicle display system (not shown) in vehicle 20, 20′ from a central server to enhance customer C's rental experience. In one embodiment in which customer C is a member of a car sharing program with an established profile, CSR R may query customer C for a profile number or other code corresponding to customer C's profile and use the profile number to initiate the downloading of software applications corresponding to customer C's profile. For example, customer C's profile may be stored in a memory of server 62, and CSR R may query server 62 for the profile information, determine the applications associated with the profile, and then manually direct the individual applications to be downloaded to the display system, or CSR R may simply instruct server 62 to download automatically the applications corresponding to customer C's profile to the display device. Alternatively, server 62 may be automatically instructed to download the applications when customer C enters a valid profile number into CID 12, 12′. CSR R may also upload information about the rental to server 62 and direct server 62 to download the information to the display system so that customer C may direct the information to be presented by the display system at any time during the rental. The display system may also be configured so that customer C may communicate with the display system, or other processing unit in or associated with the vehicle, to extend or otherwise modify the rental.

It should be noted that although CID's 12, 12′, 12″ are depicted as kiosks in the figures, any suitable device for remotely receiving and transmitting data may be used as a CID in accordance with the present invention, including, for example, a wall-mounted or desktop computer terminal, a portable computer, or any other portable data receiving and transmitting device such as a customer's cellular phone or PDA. Advantageously, where a customer's portable handheld device is used as the CID, vehicle access means may be provided in the form of a code transmitted to the handheld device, which may either be retransmitted by the handheld device to the subject vehicle, manually entered by the customer into an input device of the subject vehicle to access the subject vehicle, or displayed on the screen of the handheld device to be scanned by a code reader at a key safe or vehicle.

In addition, it should be noted that although the embodiments described above with reference to the figures generally relate to systems and methods incorporating a human CSR, systems and methods in which any or all of the functions performed by the human CSR are instead performed automatically by a remote server are within the scope of the invention. Advantageously, the remote server performing a rental transaction with a customer may run “agent assist” software configured to prompt a customer to request to be connected to a remote human CSR for assistance, either routinely or as an automatic reaction to the remote server detecting a complication in the transaction requiring the assistance of a human CSR. Optionally, the remote server may even automatically connect the customer to a human CSR upon detecting such a complication, without being prompted by the customer.

While the invention has been described with respect to certain preferred embodiments, as will be appreciated by those skilled in the art, it is to be understood that the invention is capable of numerous changes, modifications and rearrangements, and such changes, modifications and rearrangements are intended to be covered by the following claims.

What is claimed is:

1. A system for facilitating a vehicle rental and providing a rental customer with a key device for access to a vehicle comprising:
a customer interface device (CID);
a key safe located proximate to the CID containing one or more key devices;
a vehicle available for rental located proximate to the CID;
a remotely located customer service representative apparatus (CSR apparatus);
the CID including a customer data input device configured to receive data from the rental customer and a transmission device configured to transmit customer data to the remotely located CSR apparatus,
the remotely located CSR apparatus including a receiver device configured to receive said customer data transmission, an output device configured to present said customer data to a remotely located customer service representative (CSR), a CSR data input device configured to receive data from the remotely located CSR, and a transmission device configured to transmit CSR data to the CID, and
the CID further including a receiver device configured to receive said CSR data transmission, an output device configured to present said CSR data to the rental customer, and
the key safe configured to provide the customer with a key device for access to the subject vehicle.

2. The system of claim 1, wherein the key safe is integrally attached to the CID.

3. The system of claim 1 further comprising
the key safe including a locked locker containing a key device configured to access the subject vehicle;
a printer of the CID configured to print a key safe code image onto a substrate and dispense the substrate, the CSR apparatus configured to receive instructions from said remotely located CSR to direct the CID to print the key safe code image onto the substrate and to transmit said instructions to the CID to initiate printing and dispensing of the substrate with the key safe code image printed thereon; and
a scanner of the key safe configured to identify said key safe code image when said key safe code image is placed proximate to the scanner, the locked locker configured to unlock when the scanner reads the key safe code image, to permit the rental customer to manually obtain the key device from inside the locker.

4. The system of claim 3, further comprising a key fob connected to the key device, the locker including a key fob detector configured to detect the presence of the key fob in the locker, the key fob being programmed with a unique code associated with the vehicle, and the CSR apparatus configured to receive a remote signal indicating that the key fob is detected in the locker and to present a message to the CSR indicating that the key device is in the locker.

5. The system of claim 3, wherein said customer data and CSR data input devices include an input device selected from the group consisting of a keyboard, a touch screen, a microphone, and a video camera, and said output devices of the CSR apparatus and the CID include an output device selected from the group consisting of a video screen and an audio speaker.

6. The system of claim 3, wherein said key safe code image comprises a bar code and the substrate is a rental contract.

7. The system of claim 0, wherein said key safe code image further comprises an alphanumeric code and said key safe scanner further comprises an alphanumeric code input device, the input device configured to unlock the locker when the rental customer manually enters the alphanumeric code into the input device.

8. The system of claim 3, wherein said key safe further comprises an input device permitting the rental customer to provide input indicating a return process, the key safe configured so that when the rental customer provides the input indicating the return process, an available locker is automatically unlocked so that the rental customer may return the vehicle key device to the available locker at the end of the rental.

9. The system of claim 0, wherein said key safe further comprises a display device prompting the rental customer to press a button of the input device indicating a return process to automatically unlock the available locker.

10. The system of claim 1, the access providing means comprising
a printer of the CID configured to print an alphanumeric key safe code onto a substrate and dispense the substrate, the remotely located CSR apparatus configured to receive instructions from said remotely located CSR directing the CID to print the key safe code image onto the substrate and to transmit said instructions to the CID to initiate printing and dispensing of the substrate with the key safe code printed thereon; and
a key safe located proximate to the CID and including a locked locker containing a key device configured to access the subject vehicle, and an input device configured for the rental customer to manually input said key safe code, the locked locker configured to unlock when the rental customer inputs the key safe code, to permit the rental customer to manually obtain the key device from inside the locker.

11. A system for facilitating a vehicle rental and providing a rental customer with a key device for access to a vehicle comprising:
a customer interface device (CID);
a locked vehicle available for rental located proximate to the CID; and
a remotely located customer service representative (CSR) apparatus;
the CID including a customer data input device configured to receive data from the rental customer and a transmission device configured to transmit said customer data to the remotely located CSR apparatus,
the remotely located CSR apparatus including a receiver device configured to receive said customer data transmission, an output device configured to present said customer data to a remotely located CSR, a CSR data input device configured to receive data from the remotely located CSR, and a transmission device configured to transmit said CSR data to the CID,
the CID further including a receiver device configured to receive said CSR data transmission, an output device configured to present said CSR data to the rental customer, and a key device dispensing device configured to dispense a key device configured to unlock said vehicle, and
the remotely located CSR apparatus configured to receive instructions from the remotely located CSR to dispense the key device and to transmit said instructions to the CID to initiate dispensing of the key card.

12. The system of claim 11 wherein the key device is a key card.

13. The system of claim 12, the CID further comprising a key card reader configured to read data from the key card and a transmission device configured to transmit said data to a remote location, the system further including a remotely located vehicle lock activation device, the vehicle lock activation device configured to receive said key card data and to remotely activate a key card detector on the vehicle to unlock the vehicle when the key card detector detects the key card.

14. The system of claim 12, the CID further comprising a key card writer configured to write data to the key card, the vehicle further comprising a key card detector configured to read said data, and the vehicle configured to unlock when the key card detector reads said data.

15. A method of renting a vehicle and providing a rental customer with access to the vehicle via a customer interface device (CID) remotely located from a customer service representative (CSR) comprising:
the CSR using a CSR apparatus to transmit data to the customer through the CID and to receive data from the customer through the CID;
the CSR entering instructions into an input device of the CSR apparatus to instruct the CID to print and dispense a key safe code image;
a transmission device of the CSR apparatus transmitting the instructions to a receiver device of the CID;
a printer of the CID printing the key safe code image onto a substrate and dispensing the substrate with the key safe code image printed theren;
a scanner of a key safe located proximate to the CID reading the key safe code image placed proximate to the scanner, and
a locked locker of the key safe, containing a key device to the vehicle, unlocking when the scanner detects the key safe code image, to make the key device available to the customer.

16. The method of claim 15, further comprising
a key fob detector in the locked locker detecting the presence of a key fob connected to the key device in the locker and transmitting a signal to the CSR apparatus indicating that the key device is in the locker,
the CSR apparatus presenting a message to the CSR that the key device is in the locker, and
the CSR receiving the message that the key device is in the locker before entering the instructions into the CSR apparatus to instruct the CID to print and dispense the key safe code image.

17. The method of claim 15, further comprising, at the end of a rental,
the CSR transmitting further data to and receiving further data from the customer via the CSR apparatus and CID,
the CSR entering instructions into an input device of the CSR apparatus to instruct the CID to print and dispense a rental receipt,
a transmission device of the CSR apparatus transmitting the instructions to a receiver device of the CID to initiate printing of the receipt by the printer of the CID and dispensing of the receipt to be manually retrievable by the customer.

18. The method of claim 17, further comprising
the printer printing a key safe code image onto the receipt,
the scanner of the key safe reading the key safe code image placed proximate to the scanner, and
a locked locker of the key safe unlocking when the scanner reads the key safe code image to permit the customer to return the key device to the unlocked locker.

19. A method of renting a vehicle and providing a rental customer with a key device for access to the vehicle via a customer CID remotely located from a customer service representative (CSR) comprising:
the CSR using the CSR apparatus to transmit data to the customer through the CID and to receive data from the customer through the CID;
the CSR entering instructions into an input device of the CSR apparatus to instruct the CID to print and dispense an alphanumeric key safe code;
a transmission device of the CSR apparatus transmitting the instructions to a receiver device of the CID to initiate printing of the key safe code onto a substrate by a printer of the CID and dispensing of the substrate with the key safe code printed thereon; and
a locked locker of a key safe located proximate to the CID unlocking when the key safe code is received by an input device of the key safe, the locker containing a key device to the vehicle, to make the key device available to the customer.

20. A method of renting a vehicle and providing a rental customer with a key device for access to the vehicle via a customer CID remotely located from a customer service representative (CSR) comprising:
the CSR using the CSR apparatus to transmit data to the customer through the CID and to receive data from by the customer through the CID;
the CSR entering instructions into an input device of the CSR apparatus to instruct the CID to print and dispense a vehicle rental contract;
a transmission device of the CSR apparatus transmitting the instructions to a receiver device of the CID to initiate printing of the contract by a printer of the CID and dispensing of the contract; and
an on-site agent providing a key device for the vehicle to the customer upon receipt of the contract.

21. A method of renting a vehicle and providing a rental customer with a key card for access to the vehicle via a customer interface device (CID) remotely located from a customer service representative (CSR) comprising:
the CSR using the CSR apparatus to transmit data to the customer through the CID and to receive data from the customer through the CID;
the CSR entering instructions into an input device of the CSR apparatus to instruct the CID to dispense a key card configured to unlock the vehicle;
a transmission device of the CSR apparatus transmitting the instructions to a receiver device of the CID to initiate dispensing of the key card from a card dispensing device of the CID; and
a device of the vehicle detecting the key card to provide the customer access to the vehicle.

22. The method of claim 21, further comprising
a card reader in the CID reading data from the key card and transmitting the key card data to the CSR apparatus, and
the CSR inputting the key card data into a remotely located activation system to remotely activate a key card detector of the vehicle to unlock the vehicle when the key card detector detects the key card.
